(19) United States
(12) Patent Application Publication
(10) Pub. No.: US 2015/0154527 A1
(43) Pub. Date: Jun. 4, 2015

(54) WORKPLACE INFORMATION SYSTEMS AND METHODS FOR CONFIDENTIALLY COLLECTING, VALIDATING, ANALYZING AND DISPLAYING INFORMATION

(71) Applicant: LaborVoices, Inc., Sunnyvale, CA (US)

(72) Inventors: Kulvinder Singh Gill, Sunnyvale, CA (US); Brookie Guzder-Williams, San Francisco, CA (US); Ayush Khanna, San Francisco, CA (US)

(21) Appl. No.: 14/530,615

(22) Filed: Oct. 31, 2014

Related U.S. Application Data
(60) Provisional application No. 61/910,266, filed on Nov. 29, 2013.

(51) Int. Cl. G06Q 10/06

(52) U.S. Cl. CPC G06Q 10/06395

(57) ABSTRACT

The workplace information system and method described herein provide an improved method of confidentially collecting, storing, processing, validating, analyzing and reporting information. The workplace information system provides a secure communication platform, accessible to workers around the world through electronic devices such as mobile phones. The workplace information systems and methods can be configured for regional languages, and messages can be recorded in local voices. The workplace information system interface allows direct educational messaging to workers. The workplace information system also provides informational messaging to workers designed to advance their health, safety, and overall quality of life on local programs and services such as legal aid, healthcare, micro-insurance, educational scholarships and vocational training. The workplace information system collects accurate, real-time information on working conditions inside factories from workers, aggregated across factories, geographic regions and industry sections to generate actionable, metrics-based streams of information on the supply chains of corporate brands.

### RELATED APPLICATIONS

This application claims priority to U.S. Provisional Application No. 61/910,266, entitled “Systems and Methods for Confidentially Collecting and Analyzing Workplace Condition Information,” filed Nov. 29, 2013. The disclosure of U.S. Provisional Application No. 61/910,266 is herein incorporated by reference in its entirety and for all purposes.

### FIELD

The workplace information systems and methods described herein relate generally to supply chain management tools, and more particularly, to workplace information systems and methods for confidentially collecting, storing, validating, analyzing, and reporting information.

### BACKGROUND

Over the last century, an increasing amount of manufacturing has been shifted from developed countries to underdeveloped countries to save on labor costs, comply with environmental standards, and improve resource efficiency. With the ever increasing globalization of the economy, companies desire information on management practices in general, particularly regarding working and safety conditions, of their overseas suppliers to enable informed management decisions on overseas suppliers. This information has been traditionally collected through surveys or inspections. However, these traditional methods raise a number of efficiency problems.

As an example, on Apr. 24, 2013, Rana Plaza, an eight-story commercial building, collapsed in Savar, a sub-district in the Greater Dhaka Area, the capital of Bangladesh. The building collapse resulted in the death of 1,129 factory workers. Approximately 2,515 injured people were rescued from the building alive. As the Rana Plaza building collapse has demonstrated, inspection-based workplace audits are insufficient to prevent tragedies. The Rana Plaza building collapse has led to widespread discussions about corporate social responsibility across global supply chains. Based on an analysis of the Rana Plaza building collapse, experts have suggested that companies need to better audit suppliers. Furthermore, supplier auditing needs to go beyond direct relationships with first-tier suppliers. Experts determined that visibility needs to be improved if suppliers cannot be directly controlled, and that smart electronic technologies play a key role to improving that visibility. Finally, experts highlight that collaboration with local partners, across the industry, as well as with academia and the non-profit sector, is important to successfully manage social responsibility in supply chains. An early warning workplace information system based on direct, confidential feedback from workers is important to prevent future accidents and to save lives.

Modern supply chains consist of buyers who contract with suppliers who mine, harvest and manufacture, and transport goods into final products that buyers bring to market. These supply chains sometimes span the entire world, and are subject to a variety of sources of disruptions. Some disruptions are related to management practices within supplier facilities, such as the tolerance of poor safety conditions that lead to the Rana Plaza building collapse. Other disruptions result from poor stock management, poor financial management, fraud and other management practices. Supply chain disruptions can cause disrupted companies to under-perform their peers' stock performance by an average of 40% with an increased volatility compared to peers of 21%. Disruptions related to environmental and human rights violations often deplete buyers' brand images and cause buyers to expend resources to rebuild their brands.

Buyers have attempted to use a variety of tools to mitigate these risks. For example, these buyers have established codes of conduct and have required suppliers to sign binding contracts enforcing these codes. Brands subscribe to public registries of suppliers, aggregated by third-party sources, usually from publicly-available information. Buyers have mandated inspections and audits often carried out by third-party audit firms to uncover non-public information. Buyers have also introduced hotlines for allowing individuals to report on supplier misbehavior, and help lines for ensuring that individual workers know their rights and relevant resources, in the face of supplier misbehavior. Codes of conduct and other contractual tools can help to clarify responsibilities for supplier management practices but do not ensure that these practices are enforced.

Public Registries and other public reputational tools can help to aggregate the best available public knowledge about internal management practices, but the underlying data often is inaccurate, outdated, and too coarse-grained to provide actionable guidance to buyers.

Inspections, audits, and other expert-based tools are based on in-depth information collected by experts but suffer from a variety of failures. The inspections are expensive and are therefore conducted rarely and gather information only over a brief span of time, usually between one and three days. The workplace inspections also are intrusive to the suppliers and disrupt operations. The inspectors are subject to influence and corruption, for example bribes for from local management in exchange for positive inspection reports. Workplace inspectors often interview a handful of workers but do not establish sufficient trust among workers to obtain candid responses. In addition, these interviews are typically conducted on-site, and hence workers may not feel comfortable revealing the truth. Often, workers are coached beforehand, and coerced by management to respond in a positive way. Workplace inspections are not scalable to a large and fluctuating supply chain and are not capable of preventing poor management practices. Due to their transient nature, workplace inspections provide only a snapshot of information to address a real-time, continuous challenge.

Hotlines, help lines and other existing telephony services are primarily reactive in that these services capture issues raised by workers typically after poor practices have already become urgent. Therefore, hotlines, help lines and other existing telephony services are not a useful preventative tool. Workers often do not trust these services because the workers interact with the hotlines or help lines rarely (only in cases of emergency) and because the workers do not get introduced to these services independently of the supplier. As a result, workers often see hotlines as tools of the supplier, so that reporting poor practices could put the individual worker at risk of retribution from the supplier. These services often connect individuals to a live operator, a process which places fundamental limits on the number of individuals who can be served at any given time and the speed of that service. Hotlines, help lines, and other telephony services are not scalable to large numbers of individuals accessing or submitting information. Also, due to the use of live operators, the data gathered by these services often is reported to the buyers only in summarized format, leaving out details that could yield useful insights into root causes and trends underlying the urgent issues reported. Finally, these approaches do not emphasize a long-term relationship with workers, so they cannot follow-up with individual workers to validate the information reported. These weaknesses mean that hotlines see poor performance in terms of both quantity and quality of information. In fact, hotlines are often subject to pranks and inaccurate reports. Therefore, hotlines and help lines are not a viable real-time solution.

### OTHER APPLICATIONS

Socio-political risk analysis. User sentiments and attitudes can be measured in the same methods as measurement of workplace conditions and practices. Because users of the workplace information system span a broad demographic spectrum in sourcing countries, their sentiments can be a useful proxy for measuring socio-political risk factors in particular geographies and sectors.

Market Research. User earning, saving and spending attitudes and habits can be measured using similar methods. This data can be useful as inputs for developing products and services to the users' demographic segments. One example would be the micro-savings industry, extending savings tools to un-banked individuals at the bottom-of-the-pyramid.

Sentiment analysis. Sentiments of users can be measured in a straightforward way. Metrics based on users' sentiments can be useful for projecting economic and social trends, similar to existing measures of consumer confidence.

Training and Evaluation: In order to aid training efforts, users can be pushed quizzes and other relevant information to reinforce learning. This information can be aggregated to determine the effectiveness and impact of training.

Product Feedback and Training: Users of new products that are distributed to a wide audience can be trained in the correct use of the product. In addition, they can also provide feedback about how they are using the product, and what improvements they would like to see, etc.

Advertisement. Users have a definite and well-defined earning and spending potential, making them a useful audience for advertisement of relevant products and services, e.g., micro-savings tools.

Public Opinion Polling. Users could be queried so as to elicit their opinions on proposed political and policy changes. For example, users' opinions can be of interest to policy makers and analysts seeking to craft policies that reflect popular opinion on a fine-grained basis.

Recruiting. Users could be queried on their fine-grained preferences in employment conditions. These preferences can be useful to match users with likely employment opportunities. Employers that meet those conditions can benefit from exposure to users who have expressed a long-term interest in those conditions, likely yielding higher worker retention, and long-term savings for the employer.

Service Delivery. The system can also serve as a broader social network, providing services such as social media, community-building around common interests, and discussion forums, to system users.

The workplace information systems and methods disclosed herein are directed to fulfilling the needs and overcoming the problems set forth above.

### BRIEF DESCRIPTION OF THE DRAWINGS

FIG. 1A illustrates an exemplary top-level block diagram of a workplace information system, wherein information flows between a data collection module and a data analysis module.

FIG. 1B illustrates an exemplary top-level block diagram of a workplace information system, wherein information flows between a data analysis module and a results generation module.

FIG. 1C illustrates an exemplary top-level block diagram of a workplace information system, wherein information flows between a data collection module, a data analysis module and a results generation module.

FIG. 2 illustrates an exemplary top-level block diagram of the architecture of a workplace information system.

FIG. 3A illustrates an exemplary top-level block diagram of a workplace information method, comprising collecting user information and analyzing user information.

FIG. 3B illustrates an exemplary method of collecting user information and analyzing user information.

FIG. 3B-1 illustrates a first portion of the exemplary method of FIG. 3B.

FIG. 3B-2 illustrates a second portion of the exemplary method of FIG. 3B.

FIG. 4A illustrates an exemplary top-level block diagram of a workplace information method, comprising analyzing user information and generating results.

FIG. 4B illustrates an exemplary method of analyzing user information and generating results.

FIG. 5A illustrates an exemplary top-level block diagram of a workplace information method, comprising collecting user information, analyzing user information and generating results.

FIG. 5B illustrates an exemplary method of collecting user information, analyzing user information and generating results.

FIG. 5B-1 illustrates a first portion of an exemplary method of FIG. 5B.

FIG. 5B-2 illustrates a second portion of an exemplary method of FIG. 5B.

FIG. 6 illustrates a graph of a function depicting how changes in β changes the functional form for a monotonically increasing function.

FIG. 7 illustrates an embodiment of the registration process for new users.

FIG. 8 illustrates an embodiment of the process of porting the user profile to a new phone number.

FIG. 9 illustrates an exemplary embodiment of the method for recognizing that a user is a new user, registering that user, and creating a new persistent profile for that user.

FIG. 10 illustrates an exemplary embodiment of the method for recognizing a user to provide the appropriate information access or submission options.

FIG. 11 illustrates an exemplary embodiment of the method for the process of entering a survey.

FIG. 12 illustrates an exemplary embodiment of the process of entering a grievance, complaint or other open-ended actionable item.

FIG. 13 illustrates an exemplary embodiment of the process of providing informational offerings.

FIG. 14 illustrates an exemplary embodiment of missed-call system process, commonly toll-free for pre-paid mobile phone users.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

The workplace information systems and methods described herein enable collection and analysis of workplace condition information in a confidential manner. The present workplace information systems and methods provide a secure communication platform that is accessible to workers around the world, through any conventional means such as portable electronic devices such as mobile phones. In other embodiments, users can access the system through computers or even non-electronic media, such as cards or flipboards, in places where technology is scarce. The workplace information systems and methods support regional languages, and audio messages are recorded in local voices. The workplace information system interface allows direct educational messaging to workers on topics such as local labor laws, human rights, freedom of association and collective bargaining. This information can empower workers to advocate for their own rights. The workplace information system also provides informational messaging to workers that is designed to advance their health, safety and overall quality of life on local programs and services such as legal aid, healthcare, micro-insurance, educational scholarships, and vocational training. This information can be pushed to workers and pulled from workers in many ways, depending on the needs of workers and their communities, their access to various technologies, and their level of literacy. Some particular interfaces for this information flow can include: mobile phones, interactive voice response (IVR), short message service (SMS), smartphone applications, web browser base application, and physical written media.

The workplace information system 100 collects accurate, real-time information on operating and working conditions inside factories from workers 130. The workplace information system 100 ensures the anonymity of informational sources to prevent reprisals against the reporting workers 130. The workplace information collected is aggregated across one or more of: worker cohorts, workplaces, factories, geographic regions and/or industry sections in an effort to generate actionable, metrics-based streams of information on supply chains for customers 140, typically corporate brands. This information is presented in real-time, and individual pieces of information may be available as soon as they are reported, or after a predetermined delay period. The workplace information system 100 can provide customers 140 exclusive access to the workplace information intelligence for a limited period of time, providing an opportunity for customer buyers 140 to take decisive and corrective action. Once the exclusivity period for a customer 140 has expired, the workplace information can be published without revealing the identification of the revealing party, empowering consumers to direct their purchasing power to socially responsible producers and helping workers 130 make informed employment choices.

For the purpose of this application a user 130 or selected user 130 is a worker in a factory (workplace) in a selected region who has chosen to participate in the workplace information system 100. A user 130 would communicate with the workplace information system 100 in order to receive free information regarding local wages and labor rules in exchange for providing wage, quota, and workplace safety information on his/her workplace. A customer (buyer customer) 140 is a buyer of products in the supply chain for subsequent retail sales and distribution. The buyer 140 is usually a retail chain (e.g., Wal-Mart), which purchases products from an overseas supplier. The buyer 140 would access the workplace information system 100 to receive real time intelligence on the workplace information of their overseas suppliers.

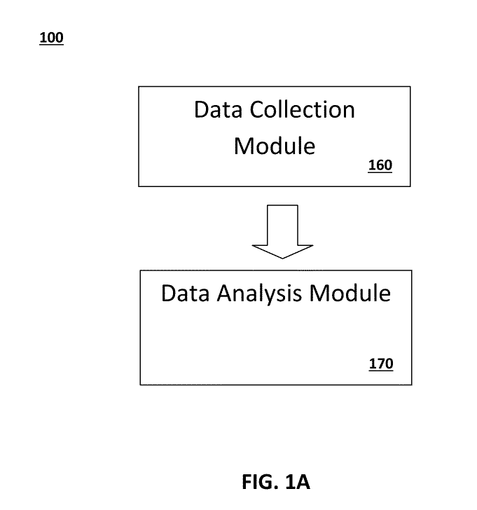

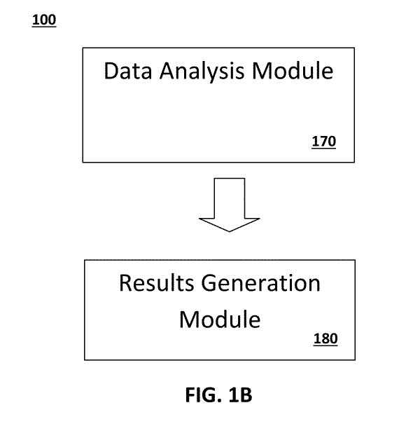

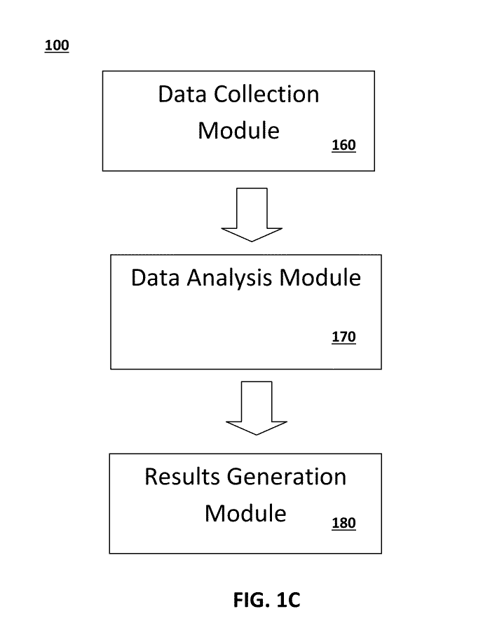

FIG. 1A illustrates one preferred embodiment of the workplace information system 100. As shown if FIG. 1A, the workplace information system includes a data collection module 160 and a data analysis module 170. Users 130 can communicate with the workplace information system 100 in any conventional manner, including through electronic devices 135 such as mobile phones. The users 130, for example, can register with the workplace information system 100, trough interaction with a trainer or by interaction with designated representatives or local organizations (for instance, Non-Governmental Organizations (NGOs)), by calling a local phone number associated with the workplace information system 100, by a referral by the user's employer, or a combination of these methods. Users 130 may discover the local phone number via local media such radio advertisements, for example. Once registered, a selected user 130 communicates with the workplace information system 100 by contacting the workplace information system 100, and/or workplace information system 100 calling the user 130. The workplace information system 100 can be configured to send and receive information using Short Message Service (SMS), web or other conventional electronic interfaces. Upon registration the workplace information system 100 forms a unique record of each user's interaction with the system, forming a unique user profile linked to both mobile telephone number and a user identification code 205. The user identification code 205 provides the workplace information system administrator, typically a LaborVoices staff member, with the ability to securely share aggregated information with customers without compromising the identity of individual workers. In one embodiment, the system data is encrypted. The workplace information system 100 also collects metadata 220 about the selected user 130. The workplace information system 100 queries the selected user 130 for more specific workplace information, for example the presence of safety hazards in the workplace. This follow-on information can be collected in any conventional manner include via a touchpad, phone keypad, audio, video, data, and/or picture input from a portable electronic device 135 such as a mobile telephone. User responses can be compared, contrasted, and verified against information collected via a different data source.

The data collection module 160 can store the information provided by the selected user 130, along with any relevant metadata 220, into a database 105. The data collection module 160 collects as much metadata 220 as possible to provide the highest possible number of potential correlates of the data input 215 into the workplace information system 100. As desired, the data collection module 160 likewise can store this metadata 220 on the database 105. Some examples of the metadata 220 collected include, but are not limited to: the time of data collection for every answer from the user 130, the location of selected user 130 (determined via cell tower location, phone number, or other mechanisms), the device number or other identification from which the selected user 130 is accessing the system, the network provider used to access the system, how the user 130 was recruited to use the system, the average amount of time taken by the user 130 to answer a question, the tone of voice, phrasing and other characteristics of the user 130 input, the reception quality, background noise, and/or other characteristics of the connection. The metadata 220 can be selectable by the customer 140 as desired. The metadata 220 for one customer buyer 140 may be the same or different from another customer buyer 140.

The data collection module 160 gathers information directly from workers (users 130) in factories, and produces reliable intelligence on whether particular management practices are, in fact implemented. This is a vast improvement over previous systems that gather information only from infrequent inspections and next level tier supply chain audits. As compared to public registries and public reputation tools, in collection information directly from workers in the specific factories in question, the data collection module 160 aggregates the information 215 of a selected user 130 accurately in real-time, yielding granular, immediate, accurate and actionable intelligence. In contrast to infrequent inspections of workplaces, the data collection module 160 updates on a continual basis, as selected users 130 report in on their own, and as the data collection module 160 has the capability to call out to workers 130 in the database 105 to request updates. The data collection module 160 methods are less intrusive to the supply and do not disrupt operations because information is collected during times that are convenient to workers (users 130) and management, typically when a worker (user 130) is off-duty.

The data collection module 160 is scalable to a large and fluctuating supply chain. The workplace information system 100 relies primarily on asynchronous communication with workers (users 130), via ubiquitous electronic devices 135 such as mobile phones, while allows for scale similar simultaneous interaction to many users 130 across many workplaces.

The data analysis module 170 correlates the metadata 220, the selected user's profile data, workplace information 215 provided by the selected user 130 and information independently known by the systems 225. This correlation allows the workplace information system 100 to target particular users 130 and situations to secure the most accurate workplace intelligence in order to detect patterns that suggest manipulation or bias within the data, or large variations from expected values, and counteract those manipulations. In one embodiment, the data analysis module 170 can include at least a computer processor 225 in communication with the database 105 containing the information from the data collection module 160. The workplace information system 100 can be comprised of various computing devices to enter data, analyze the data and generate results. These computing devices described herein (e.g., personal computers, handheld computers, servers, portable electronic devices) may be comprised of commercially available computers, hardware and operating workplace information systems. The aforementioned computing devices are intended to represent a broad category of computer systems capable of functioning in accordance with the present workplace information system 100 and method 190. The computing devices may include various components, peripherals and software applications provided they are compatible and capable of performing functions in accordance with the present workplace information system 100 and method 190. The computing devices also include information, documents, data and files needed to provide functionality and enable performance of methodologies in accordance with an exemplary embodiment of the workplace information system 100 and method 190. The computers and electronic systems disclosed consist of processors 225 that perform the electronic processes capable of performing the methods 190 disclosed herein.

The data collection module 160 reduces susceptibility to influence and correction such as bribes for good inspection results. The data collection module 160 collects intelligence from a broader variety of sources—workers (users 130) and other individuals—versus relying only on a few inspectors. Therefore the workplace information system 100 analyzes the sources of information for signals of bias and inaccuracies, and down-weights sources that appear to be compromised.

The workplace information system 100 is designed to establish long-term relationships with workers (users 130), potentially providing information services to workers (users 130) throughout their working lives. These relationships form the basis of trust among workers (users 130), inspiring participation and reliable reports of information. Previous inspection methods often interview only a handful of workers (users 130), but do not establish sufficient trust among workers to obtain candid responses.

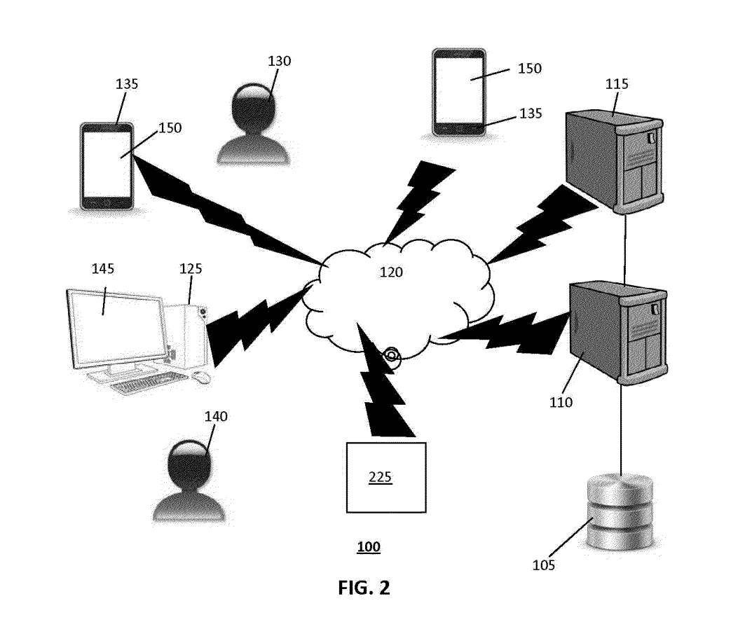

The computer processor 225 correlates the metadata 220 to the input data and assigns a weighting factor for each user and saves this information on the database 105 (shown in FIG. 2). The correlation data is stored in the database 105 linked to the relevant selected user 130 profiles. If the workplace information system 100 detects that a particular user 130 is attempting to manipulate the workplace information system 100 through inconsistent data entry, the workplace information system 100 can remove or down-weight the entire contribution, or selected portions, of data from that particular user 130. The workplace information system 100 can use the correlation data to evaluate past and/or future information submitted by the selected user 130 to build a model that determines whether—and if so, how much—information provided by the selected user 130 should be relied upon relative to other users 130 and external sources of information. The higher the correlation between the workplace information provided by the selected user 130 and the metadata 220 and verifiable information 227, the higher the weighting factor the input data receives. The workplace information system 100 also analyzes correlations of the user's inputs with the inputs of other users and other factors, correlations of input across groups of users with other groups of users and other factors, and correlations between inputs and events at different times for possible predictive associations. The resultant data is associated not just with individual user profiles, but also profiles of groups of users, factories, regions, sectors, and other entities.

The data analysis module 170 converts the information provided by many users 130 into customer intelligence. Customer intelligence is comprised of aggregated workplace information generated from a plurality of users 130 over a set period of time. The workplace information system 100 creates profiles of the selected users 130 comprising all relevant data related to that selected user 130. The reliability of the user-provided information 215 is independently verified and used to determine a reliability score for the selected user 130. For example, one iterative process includes gathering data from a pool of users 130, such as each user's assessment of whether a fire escapes in his/her workplace is locked. The workplace information system 100 then uses a selected user's respective reliability metrics to weight the selected user's respective assessment of the state of fire escapes, and combine those assessments to create an overall assessment of whether the fire escapes are locked. The status of the fire escapes is independently verified, measuring the accuracy of those assessments. Based on the measurement of the reliability of information provided, the workplace information system 100 revises reliability metrics that are assigned to the user, groups of users, factories, regions, sectors, and other entities. These reliability metrics then are used to weight the next batch of data gathered from the users 130 to produce the next batch of customer intelligence, and so on. The process described above can be applied to many other common workplace scenarios, including but not limited to: fire and safety training, incorrect and unpaid wages, unpaid overtime, verbal/physical/sexual harassment, presence of child labor, or any other violations of local laws or company policy.

Another embodiment is data analysis module 170, comprising of a data representation module, a data manipulation module and an analysis generation module. In this embodiment, the data representation module takes incoming data and sorts it according to the data model.

The data model arranges data into groups of objects. A group may contain other groups, referred here as subgroups. A group is used to organize general objects called Docs (e.g., Surveys, Information Offerings, etc.) and their subsequent users 130 and responses. At the top level a group in most cases is associated with a particular customer 140 and the subgroups are smaller divisions of items relevant to a customer's operations, e.g., a factory or group of factories, a migrant worker camp, etc.

A Document or Doc is any content that is offered to the selected users 130 (e.g., factory workers, farmers, laborers). Examples of Docs can include surveys, information offering and grievance handling.

A survey can ask specific questions of the user 130. An information offering can push information to the user 130 (e.g., worker rights). A grievance handling system can be an open ended system that allows users 130 to report problems. A Document (Doc) is comprised of pages: questions or statements that communicate with the user 130. A page that requires user 130 input is referred to as a question.

A response can be the information gathered from the user 130 during a single interaction with the workplace information system 100. In some cases (e.g., surveys and grievance handling) this can include direct user input, responses to questions or the grievance report. A response can also include metadata on a large variety of quantitative and qualitative information, such as when the user 130 called, how long the user 130 took to answer a question, the tone of voice and the grammar and speech pattern of the user 130. Response modes can take the form of true/false, single choice from a list, multiple choice, or open-ended messages. The ordering of pages as well as response modes can be changed, manually or algorithmically, or randomized for each response, to ensure high data quality.

An answer can refer to the user's input to any question.

A user 130 can refer to any user of the workplace information system 100. Examples include but are not limited to factory line workers, management, farm workers, and construction laborers.

In one embodiment, the data manipulation module can collect data from the data representation module and perform statistical operations on it according to the statistical model.

The statistical model calculates various statistical quantities that are used to interpret the data and metadata to derive insights for users 130 and customers 140. Some examples include average, weighted average, median, mode, range, expectation value, and variance. Some of the variables analyzed can include: the Average Answer to Question Q (A_{Q}), the Trust of Group G (T_{G}), the Trust of User U (T_{U}), and the Utility of a Survey S (U_{S}).

The statistical model may calculate (weighted and non-weighted) expectation values. This calculation can be performed by setting the following variables: O, M aᵢ, and pᵢ. The desired quantity to be measured (e.g., Trust, Utility) can be set as O. The object of interest (e.g., Group, User, Survey) can be set as M. The value for a given criteria being used (e.g., Score, a, time with the workplace information system 100) can be set as aᵢ. The variable aᵢ is the i^{th} value of a for a given criteria the workplace information system 100 is using (e.g., Score, σ, time with the workplace information system 100). The criteria aᵢ can be normalized or defined as having a value between 0 and 1. For example, a raw score for a particular user 130 would be the percentage of correct answers given by the “correct” answers provided by the user 130 to questions used to verify their authenticity. In contrast a User's Trust may be based on the time the User has interacted with the workplace information system 100, and might be given by a monotonic function whose lower bound is at t=0 and asymptotically approaches 1 as t approaches infinity.

The relative importance of aᵢ in determining O can be set as pᵢ. The initial value for pᵢ can be initially added to the system using human intelligence to make reasonable estimates. However, the statistical model is designed to learn as the workplace information system 100 gathers more data and can adjust the value for pᵢ accordingly. One example for calculating pᵢ can include selecting a standard criteria of known importance, for example the score, and use the sample correlation coefficient to determine the value for pᵢ. The weighted expectation value is then given by the weighted average equation:

$${( O )}_{M} = \frac{{\sum }_{i = 0}^{N - 1} {p}_{i} {a}_{i}}{{\sum }_{i = 0}^{N - 1} {p}_{i}}$$

Then the non-weighted expectation value, which is simply the special case where pᵢ=1 for all values of i, is given by the average value:

$${( O )}_{M} = \frac{1}{N} {\sum }_{i = 0}^{N - 1} {a}_{i}$$

Along with computing the expectation values, the statistical model also can calculate the confidence value (C_{Q}) for each question. The confidence value (C_{Q}) should be understood as the trust that should be placed in the expectation value of a given question. Confidence Value (C_{Q}) can be measured with values between zero, indicating no confidence to one, indicating 100% confidence. However it should be noted that in practice there is an upper bound in confidence value which is less than one. If, for instance, 10,000 users 130 answer a question in exactly same way it is likely that the workplace information system 100 is being gamed. Flags can be set to catch such scenarios, alert the system administrator and/or customer 140 so that the issue may be investigated further.

One example how the workplace information system 100 can compute confidence is:

CQ=1−σR

### Where σ_{R} is the Relative Standard Deviation:

$${σ}_{R} = \frac{1}{\overline{a}} \sqrt{\frac{1}{N} {\sum }_{i = 0}^{N - 1} {( {a}_{i} - \overline{a} )}^{2}}$$

Or its weighted version:

$${σ}_{R} = \frac{1}{( {A}_{Q} )} \sqrt{\frac{{\sum }_{i = 0}^{N - 1} {( {a}_{i} - ( {A}_{Q} ) )}^{2}}{{\sum }_{i = 0}^{N - 1} {p}_{i}}}$$

Addition Metadata. In addition to the data and metadata collected for the above statistical model, the data collection module 160 collects data that currently is not being used but can prove useful at a future point in time and may eventually be added to the models discussed above. For example, to determine a User's Trust T_{U}, one or more of the following can be used: the workplace information system 100 can use the user's average score, the user's average deviation from the all the users 130 in the group, and the total number of responses recorded for the user 130. In addition, other metadata such as user pause time before answering a question is also collected. If this information is strongly correlated with the User's Trust, it can be added to the user statistical model. Alternatively, this information may be kept separate from the statistical model but used to determine if responses from relatively new users 130 (for whom the system has little data) should be trusted.

Generally speaking, the importance of additional metadata will be determined by the metadata's correlation with the data that is already part of the model.

The correlation may be determined in a variety of ways, for instance using the sample correlation coefficient:

$${r}_{ab} = \frac{{\sum }_{i = 0}^{N - 1} ( {a}_{i} - \overline{a} ) ( {b}_{i} - \overline{b} )}{\sqrt{{\sum }_{i = 0}^{N - 1} {( {a}_{i} - \overline{a} )}^{2} {\sum }_{i = 0}^{N - 1} {( {b}_{i} - \overline{b} )}^{2}}}$$

What follows is a partial list of the criteria that can be used in the statistical models discussed above. The workplace information system 100 can include additional data that is collected by the workplace information system 100 and eventually added into the statistical models.

Average Answer to a Question (A_{Q}). Calculating the non-weighted average answer A to a question Q, <A_{Q}> is simply the average for all the responses given to the question.

The weighted expectation value, <AQ>W, is calculated by weighting the answer of each user 130, using the trust values of the users 130 as the weights, pᵢ=<TU>ᵢ

In the model several kinds of data are being used to determine <A_{Q}>^{W} however they are buried in calculating the expectation value of the Trust of the i^{th} user <T_{U}>ᵢ to be discussed in detail below.

As previously discussed a group can be comprised of many subgroups. To calculate <T_{G}> for a group with subgroups the criteria a, are simply the <T(_{sub})_{G}> of the subgroups with the pᵢ values being the importance of the group. The pᵢ values can be determined by other criteria such as the number of workers 130 in each subgroup, etc. To determine the trust of a given base Group (one without subgroups) the workplace information system 100 can consider the following criteria: the average user Trust, the Time with the workplace information system 100, and the Number of Responses. The average user Trust can be represented by T_{U(G)}. Both weighted and non-weighted versions can be calculated. Time with workplace information system 100 can be represented by t_{G}. The number of responses can be represented by N_{R(G)}.

The Trust of a User (T_{U}) depends on the following criteria: the user score (S_{U}), the user repeatability score (r_{U}), the time with workplace information system 100, and the Number of Responses. The user score (S_{U}) can calculated as the percentage of verifiably correct answers for that user. The user repeatability score (r_{U}) can represent the consistency between answers to the same questions asked in different ways.

The Utility of a Survey (U_{S}) is a measure of how useful the survey is and can depend on the following criteria: Number of responses (N_{R(D)}), the average completeness of a survey C_{S}, and the survey score S_{U}. The average completeness of a survey c_{S} can be calculated as the number of answers (N_{A}) divided by the product of the number of responses (N_{R}) and the number of questions in the survey (N_{Q}).

As previously discussed in subsection, not all data that the workplace information system 100 collects are used in all embodiments of the statistical model. However, the statistical model can be updated based on trends and correlations and updated models can incorporate this data into the workplace information system 100 in the future. Some examples of additional data can include: How long a user pauses before answering a question; the quantity and characteristics of background noise during the call; the date and time of the call, especially as contrasted with the work day; where and how the user 130 was recruited into the system; other users 130 or organizations the user 130 is connected to, particularly to leadership positions, when those positions are demonstrably effective, according to the workplace information system 100 analysis; the user's work history, tenure at current and previous employers, and leadership positions taken; any location information on the user 130; the phone number from which the call is made; the tone of voice, phrasing and other characteristics of the user's input; and the reception quality and other characteristics of the connection the user makes with the workplace information system 100.

A Model for Monotonically Increasing Trust. When considering how much to trust a user 130 or Group, the workplace information system 100 often needs to consider criteria that are monotonically increasing. For example, how long has the user been with the workplace information system 100, how many surveys the user 130 has completed, etc.

The following equation can model such behavior with:

f(x)=y₀+(1−y₀)(1−e^{-βx})

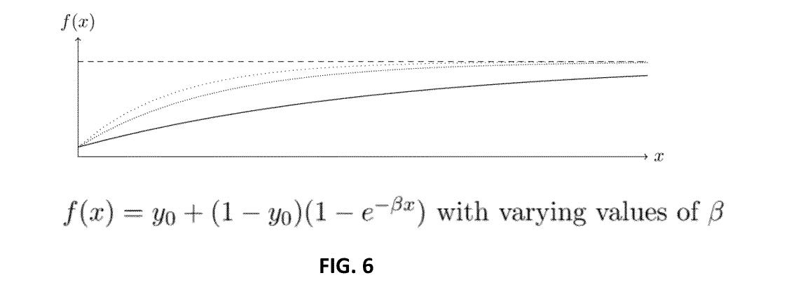

This is a simple function with only two parameters. y₀ gives the initial value. For instance if the workplace information system 100 is considering the number of responses for a particular user, y₀ represents how much trust to place the very first response of the user 130. β controls how fast the function approaches 1. Returning to our example, β controls how quickly the workplace information system 100 can increase the trust in the user 130 based on the number of responses the user 130 has previously provided. FIG. 6 illustrates how β changes the functional form.

The data analysis module 170 provides an early warning system of poor management practices, and allows customer buyers 140 to intervene with suppliers before these poor practices result in dire consequences.

This customer intelligence can include absolute and/or relative statements for example: Factory A pays more than Factory B; Factory A pays more than the minimum wage unlike Factory B; User X should work at Factory A rather than Factory B for the following reasons; and or Customer Y should chose Factory A over Factory B to reduce the risk of supply chain disruptions.

FIG. 1B illustrates an embodiment of the workplace information system 100, wherein the information flows from the data analysis module 170 to a results generation module 180. As discussed in more detail above with reference to FIG. 1A, the data analysis module 170 can analyze information contained on the database 105. The data analysis module 170 provides the correlation between user metadata 220, input information, and known information for the region. The weighted workplace information provided by the data analysis module is available for the results generation module 180 for customer consumption.

The results generation module 180 can include a processor 225 connected to a database 105. In one embodiment, the processor 225 can be the same processor 225 associated with the data analysis module 170. The analysis results generation module 180 can produce various outputs based on buyer customer 140 requests. The analysis results can include information, such as information regarding wages, working conditions, and safety violations at various workplaces. The analysis results may be presented in any conventional manner such as via hardcopy print reports and/or on-screen displays. In one embodiment, analysis results may be presented in tabular, text, or via charts. The customer information can include workplace-specific, or industry-specific analysis results for a given region. The results generation module 180 can be configured to provide periodic updates and/or for a specific inquiry. In one embodiment the results generation module 180 may send the results electronically, such as email messages, directly to the selected customer 140.

FIG. 1C provides yet another embodiment of the workplace information system 100. The workplace information system 100 of FIG. 1C is shown comprising a data collection module 160, a data analysis module 170, and a results generation module 180. The interaction between these modules is set forth in FIGS. 1A and 1B as set forth in the paragraphs above.

FIG. 2 illustrates a high-level block diagram of an exemplary workplace information system 100, wherein the system elements are shown as comprising networked computer elements. Turning to FIG. 2, the workplace information system 100 is disclosed including a database 105. The database 105 is a computer database that contains workplace and worker information 210 from a plurality of workers 130 in a given region. The database 105 is periodically updated, e.g. daily or continuously, to include the most accurate, up-to-date worker information. In one embodiment, the database 105 used is an indexed flat file database. The database 105 is communicatively connected to a database server 110, and may reside on the database server 110. The database can reside on a separate computer and/or one or more separate database storage devices. The database server 110 hosts a database management workplace information system for managing the tasks of writing and reading data to and from the database 105. The database server 110 controls the flow of information to and from the database 105.

The database server 110 is communicatively connected to a web server 115. The web server 115 hosts information, documents, scripts needed to provide user interfaces and enable performance of methodologies in accordance with an exemplary embodiment of the workplace information system 100 and method 190. By way of example and not limitation, the web server 115 may include web page information, documents and scripts (e.g., HyperText Markup Language (HTML) and Extensible Markup Language (XML)), applets, and application software, which enables users 130 to submit workplace information in response to information requests from customer buyers 140. The web server 115 connects the database server 110 to the communications network 120 such as the Internet. In one embodiment the web server 115 may reside on the database server 110. In another embodiment the database server 110 may allow for connection of the database 105 to the communications network.

In one embodiment, access to the web server 115 is accomplished through use of a personal computer 125 which is electronically connected to the communications network 120. This connection can be achieved through a wired and/or a wireless local area network.

A plurality of users 130 can access the web server 115 using compatible computing devices with network connectivity. By way of example, such devices can include at least one personal computer, laptop computer, handheld computer, personal digital assistant, kiosk, mobile phone and/or any compatibly equipped electronic computing device. User computing workplace information systems 100 can include an operating workplace information system 100 and a browser and/or similar application software configured to properly process and display information, documents, software, applications, applets and scripts provided by the web server 115. Although only one personal computers 125 and two portable electronic devices 135 are shown in FIG. 2 for illustrative purposes only, any number of user computers and portable electronic devices 135 may be used in accordance with the workplace information system 100.

In one embodiment, access to the web server 115 is accomplished through use of a portable electronic device 135 which electronically communicates with the communications network 120. The portable electronic device 135 can electronically connect directly to the communications network 120 and/or be operably connected to a personal computer 125 that connects to the communications network 120.

In one embodiment, a user 130 may access the workplace information system 100 via a portable electronic device 135 through an application and/or through a personal computer 125 via use of a web browser.

In an alternative embodiment, a customer 140 can access the workplace information system 100 through a portable electronic device 135 via an application and/or through a personal computer 110 through use of a web browser.

In one embodiment, the users 130 and/or customers 140 access the database 105 and the workplace data through an application programming interface (API). An application programming interface is a protocol intended to be used as an interface by software components to communicate with each other.

In one embodiment, the customer information may be depicted on the display 145 of a personal computer 125 and/or display 150 of portable electronic device 135.

The workplace information system 100 is not limited to any particular network connectivity or communication protocol. Various forms of communication networks may be used by personal computers 125 and/or portable electronic devices 135 to access the web server 115. By way of example and not limitation, a proprietary Wide Area Network (WAN) or a public WAN, such as the Internet 120, may be used. These networks typically employ various protocols such as the HyperText Transfer Protocol (HTTP), File Transfer Protocol (FTP), Extensible Markup Language (XML), and Transfer Control Protocol/Internet Protocol (TCP/IP) to facilitate communication of information between communicatively coupled computers. The workplace information system 100 may also utilize wireless networks, including those utilizing Global Workplace information system for Mobile (GSM), Code Division Multiple Access (CDMA) or Time Division Multiple Access technology, the Wireless Application Protocol (WAP), and Long Term Evolution (LTE) communication protocol. Furthermore, the workplace information system 100 may utilize any, all, and any combination of such communications networks, as well as communications networks hereafter developed.

As desired, a firewall can be located between web server 115 and the database server 110 to protect against corruption, loss, or misuse of data. The firewall limits access by the web server 115 and prevents corruption of data. Thus, the web server 115 can be configured to update and receive data only to the extent necessary. The firewalls can be comprised of any hardware and/or software suitably configured to provide limited or restricted access to the database server 110. The firewalls can be integrated within the database server 110 and/or another workplace information system component, or may reside as a standalone component.

Functions and process steps described herein may be performed using programmed computer devices and related hardware, peripherals, equipment and networks. When programmed, the computing devices are configured to perform functions and/or carry out tasks in accordance with principles of the disclosed workplace information system 100 and method 190. Such programming can comprise operating workplace information systems, software applications, software modules, scripts, files, data, digital signal processors (DSP), application-specific integrated circuit (ASIC), discrete gate logic, and/or other hardware, firmware, and/or any conventional programmable software, collectively referred to herein as a module.

The workplace information system 100 is adapted to receive and/or process workplace information from users 130 and information requests from customers 140. Customer information can be generated from manual and/or scanned entries. In one embodiment, a request can include workplace conditions, safety violations, wages at a given workplace or industry in a given region. Customer information requests 405 are received by the web server 115, where the requests 405 are processed into queries for the database server 110. In response to customer information requests 405 and/or corresponding queries, the database server 110 searches the database 105 for a matching records and returns the correlated information based on the customer request 405 either via a web application or mobile application.

In one embodiment, the workplace information system 100, comprises: an electronic device 235 for entering a survey information 215 regarding the workplace; a network 120 in communication with the electronic device 235; a database server 110 in communication with the network 120 configured to record the survey information 215 and a plurality of metadata 220 associated with the electronic device 235; and a processor 225 in communication with said database 105 configured to analyze the survey information 215 and output a report.

In one embodiment of the workplace information 100, the system 100 further comprises an interactive voice message system for collecting workplace survey information 215.

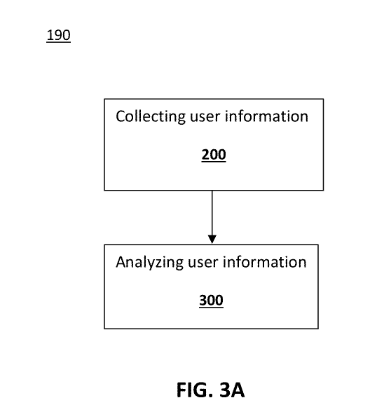

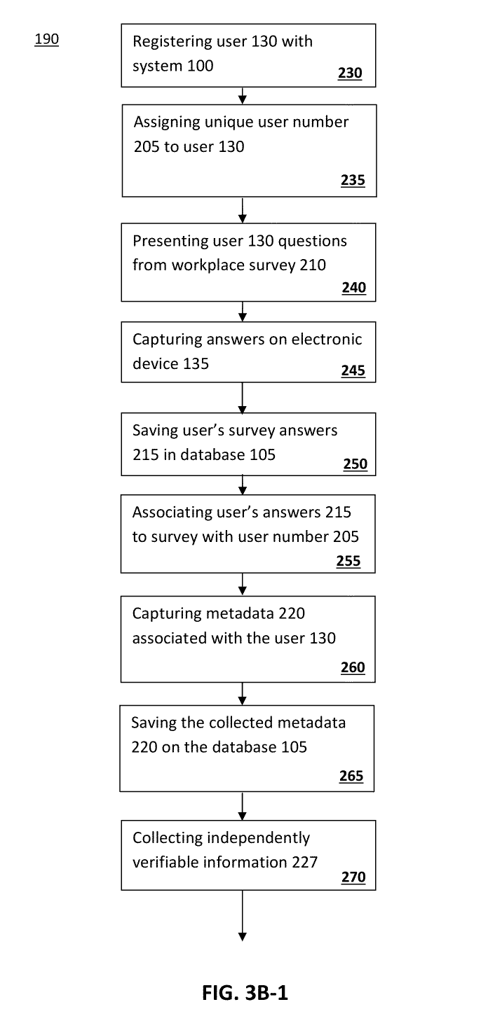

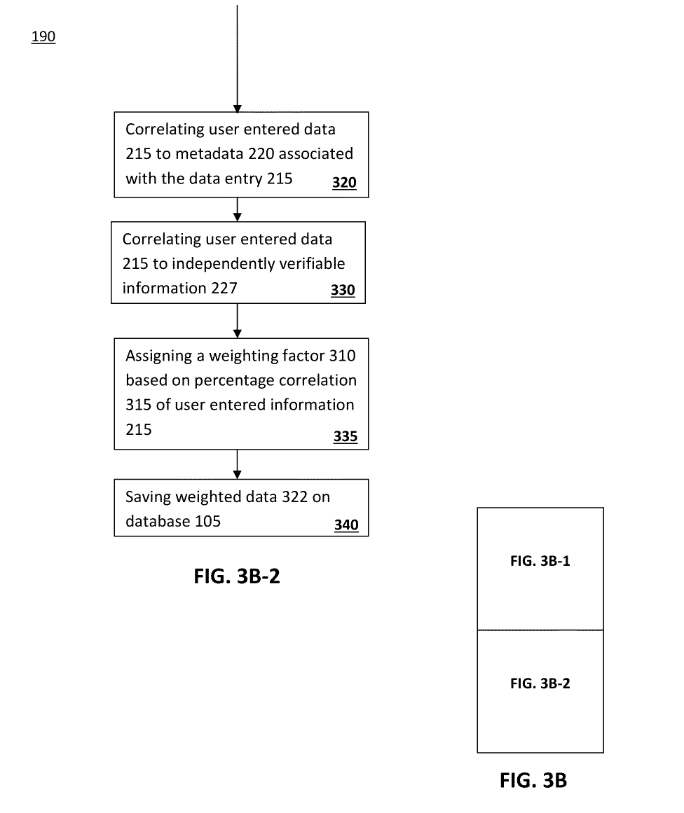

FIG. 3A illustrates an exemplary top-level block diagram of a workplace information method 190, comprising a method of collecting user information 200 and a method for analyzing user information 300. The collection of user 130 survey data 215 can be accomplished by various means to include recording electronic survey answers, voice recognition software, recording spoken voice answers for later transcription and entry of responses, or manual collection using a live person to record and enter answers.

One method of collecting user information is illustrated in FIG. 3B-1. The data collection method comprises registering, at 230, the user 130 with the system 100. Next, the user 130 is assigned, at 235, a unique user number 205. The user 130 is presented, at 240, questions from a workplace survey 210. The user's answers 215 to those questions can be captured, at 245, on an electronic device 135 such as a mobile phone. The user's answers 215 are saved, at 250, in a database 105. The user's answers 215 are associated, at 255, with a user's number 205. Metadata 220 associated with the user 130 is captured, at 260, by the data collection module 160 and is saved, at 265, on the database 105. Independently verifiable information 227 is collected, at 270, through the assistance of local and/or non-governmental organizations. The independently verifiable information 227 is also saved on the database 105.

One method of analyzing user information is illustrated in FIG. 3B-2. The method of analyzing user information 215 comprises correlating, at 320, the user entered data 215 with the metadata 220 associated with the data entry 215. Next, the user entered data 215 is correlated, at 330, with independently verifiable information 227. Next, a weighting factor 310 is assigned based on a percentage correlation 317 of user entered information 215. The weighed data 322 is saved as 340 on the database 105.

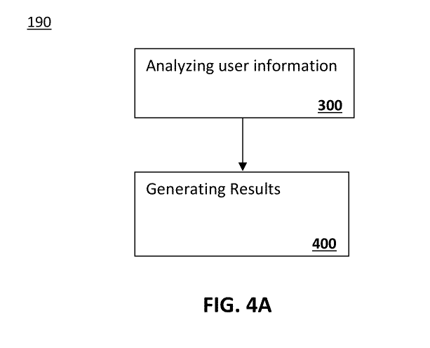

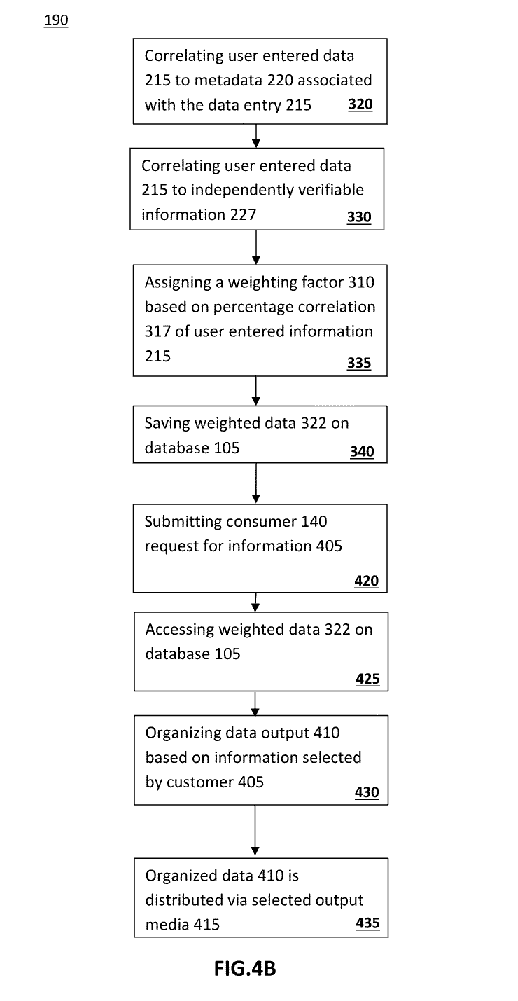

FIG. 4A illustrates an exemplary top-level block diagram of a workplace information method 190, comprising a method for analyzing user information 300 and a method for generating results 400. FIG. 4B illustrates one method of analyzing data and generating results. The method of analyzing data is identical to method described in FIG. 3B-2. The method of generating results 400 is comprised of a buyer customer 140 submitting, at 420, a request for information 205. The processor 225 accesses, at 425, the weighted data 322 on the database 105. The workplace output data 410 is organized, at 430, based on the buyer customer selected criteria 405. The output data 410 is distributed, at 435, via the selected output media 415.

In one embodiment the method 190 for providing workplace information for each of a predetermined number of workers 130, each of whom work for a common workplace, comprising: associating a selected worker 130 with a unique identifier 215 and a trust factor value 310; receiving information about the workplace from the selected worker 130 via an associated electronic device 235; comparing the information received 215 with a plurality of reliable baseline information 227; updating the trust factor value 310 based on said comparing; aggregating the information provided by each of said selected workers; and generating an aggregate trust value from the updated trust value of each of the selected workers.

In one embodiment, the method 190 further comprises receiving information about the workplace comprises receiving quantified answers to a predetermined number of questions.

In one embodiment, the method 190 further comprises assigning priority to the information based on a customer selected criteria.

In one embodiment, the method 190 further comprises, generating a report 410 comprising of the aggregated information and the aggregated trust value; and presenting the report as requested by customer 140.

In one embodiment, the method 190 further comprises receiving a plurality of metadata 220 associated with said selected worker 130; and saving said metadata 220 to a database 105.

In one embodiment, the method 190 further comprises comparing said metadata 220 received with the reliable baseline information 227; and updating the trust value 310 based on said comparing.

In one embodiment, the method 190 further comprises identifying sections of workers 130 based on the information 215 received from the workers and the corresponding metadata 220.

In one embodiment, the method 190 further comprises electronically transmitting, at 750, an informational offering to the selected worker 130 or sections of workers based on the workplace information received 215 and corresponding metadata 220.

In one embodiment of the method 190 the trust value is provided a default value for said worker 130 if said worker 130 is new to the workplace information system 100.

In one embodiment of the method 190 the electronic device 235 comprises a cellular telephone.

In one embodiment, the method 190 further comprises calculating an expectation value based on information about the workplace received.

In one embodiment, the method 190 further comprises calculating a utility value for a survey completed by the selected worker.

In one embodiment, the method 190 further comprises providing the selected worker an option to view a workplace informational offering.

In one embodiment of the method 190 said informational offering includes one of workplace pay information, workplace safety conditions, workplace hours, or worker rights.

In one embodiment, the method 190 further comprises calculating a confidence value for a survey completed by the selected worker.

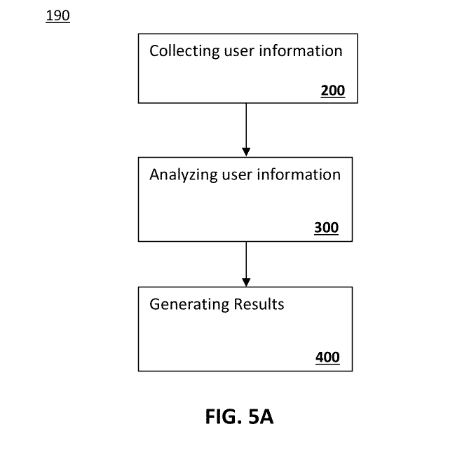

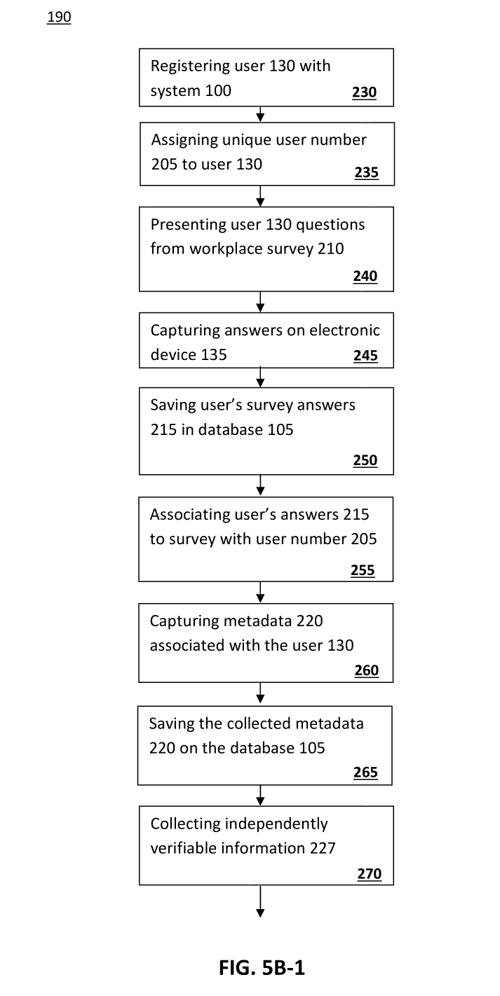

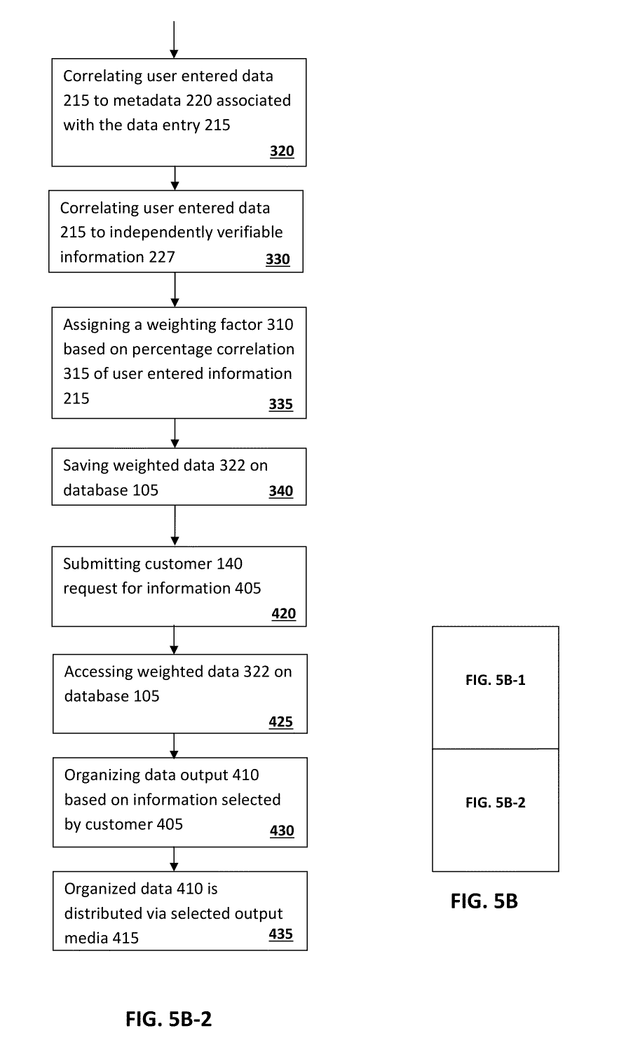

FIG. 5A illustrates an exemplary top-level block diagram of a workplace information method 190, comprising a method for collecting user information 200, a method for analyzing user information 300 and a method for generating results 400. One method of collecting user information is illustrated in FIG. 5B-1. The data collection method comprises registering 230 the user 130 with the system 100. Next, the user 130 is assigned, at 235, a unique user number 205. The user 130 is presented, at 240, questions from a workplace survey 210. The user's answers 215 to those questions can be captured, at 245, on an electronic device 135 such as a mobile phone. The user's answers 215 are saved, at 250, in a database 105. The user's answers 215 are associated, at 255, with a user's number 205. Metadata 220 associated with the user 130 is captured, at 260, by the data collection module 160 and is saved, at 265, on the database 105. Independently verifiable information 227 is collected, at 270, through the assistance of local and/or non-governmental organizations. The independently verifiable information 227 is also saved on the database 105.

One method of analyzing user information is illustrated in FIG. 5B-2. The method of analyzing user information 215 comprises comparing, at 320, the user entered data 215 with the metadata 220 associated with the data entry 215. Next, the user entered data 215 is correlated, at 330, with independently verifiable information 227. Next, a weighting factor 310 is assigned, at 335, based on a percentage correlation 315 of user entered information 215. The weighed data 322 is saved, at 340, on the database 105. The method of generating results 400 is illustrated in FIG. 5B-2 and comprises a buyer customer 140 submitting, at 420, a request for information 207. The processor 225 accesses, at 425, the weighted data 322 on the database 105. The workplace output data 410 is organized, at 430, based on the buyer customer selected criteria 405. The output data 410 is distributed, at 435, via the selected output media 415.

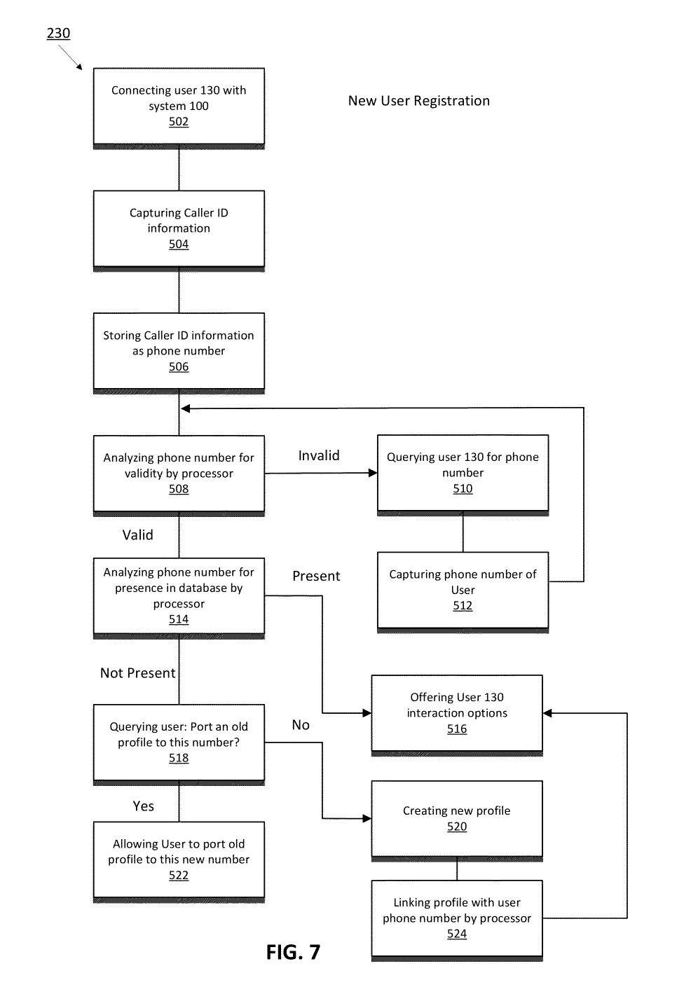

FIG. 7 illustrates the process for new user 130 registration. Initially, a user 130 connects, at 502, with the system 100. In one embodiment, this initial connection can occur when the user 130 calls a designated telephone number. The user 130 can also connect with the system 100 by registered through a website or through the assistance of representatives of non-governmental organizations or the workplace information system administrative personal. Next, the system 100 will capture, at 504, a caller identification (Caller ID) information of the user 130. The caller ID information can be stored, at 506, through any conventional means in the database 105. The processor 225 can analyze, at 508, the phone number obtained from the Caller ID information for validity. If the processor 225 detects that the phone number is invalid, the system 100 queries, at 510, the user 130 for another phone number. The processor 225 can capture, at 512, the new phone number of the user 130. The processor 225 can then analyze, at 508, the new number provided for validity.

If the processor 225 determines the phone number is valid, the processor 225 can analyze, at 514, if the number is present in the database 105. If the processor 225 establishes that the phone number is present in the database 105, the processor 225 offers, at 516, the user 130 interaction options. If the processor 225 detects that the number is not present in the database 105, the processor 225 can query, at 518, if the user 130 wants to port an old profile to the number. If the user 130 desires to use an old profile, the processor 225 will associate, at 522, the new number with the old profile. If the user does not want to import an old profile to this number, the processor 225 will prompt, at 520, the user 130 to create a new profile. The processor 225 can link, at 524, the profile with the phone number.

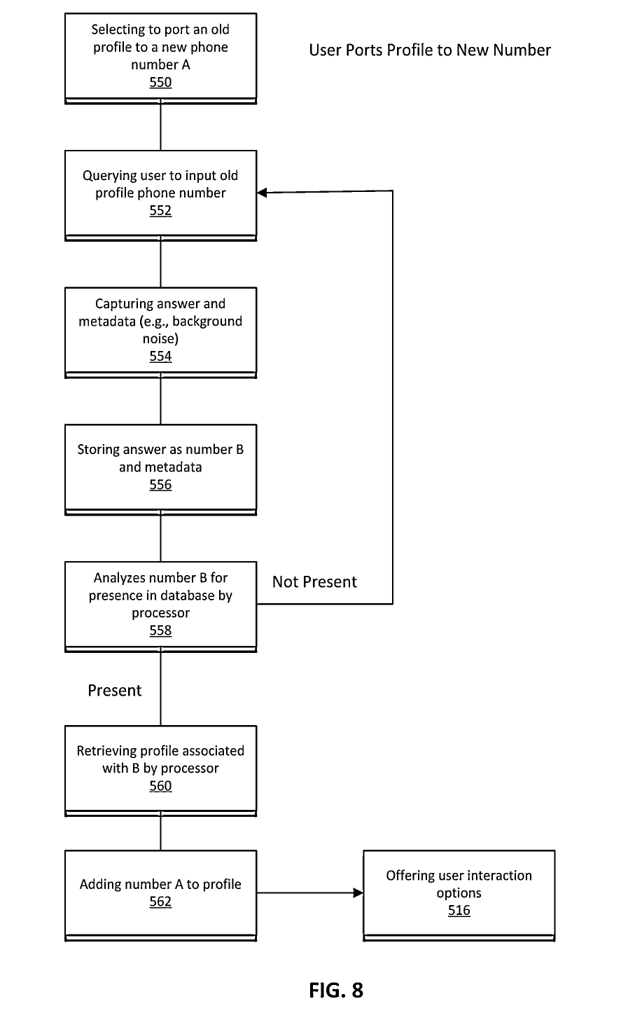

FIG. 8 illustrates an embodiment of the process of porting the user profile to a new phone number. The processor 225 prompts the user to select, at 550, to port an old profile to an new number A. The processor 225 queries, at 552, the user 130 to input old profile phone number. The processor 225, can capture, at 554, the answer and metadata associated with the answer of the user (for example, the background noise). The processor 225 can store, at 556, as number B and the associated metadata in the database 105. The processor 225 can analyze, at 558, the number B for presence in the database 105. If the processor 225 determines that the number is not present in the database, the processor 225 can query the user 130 to input old profile number. If the processor 225 determines that the phone number is present in the database, the processor can retrieve, at 560, the profile associate with phone number B. The processor 225 can add, at 562, number A to the profile. The processor 225 can offer, at 516, the user 130 interaction options.

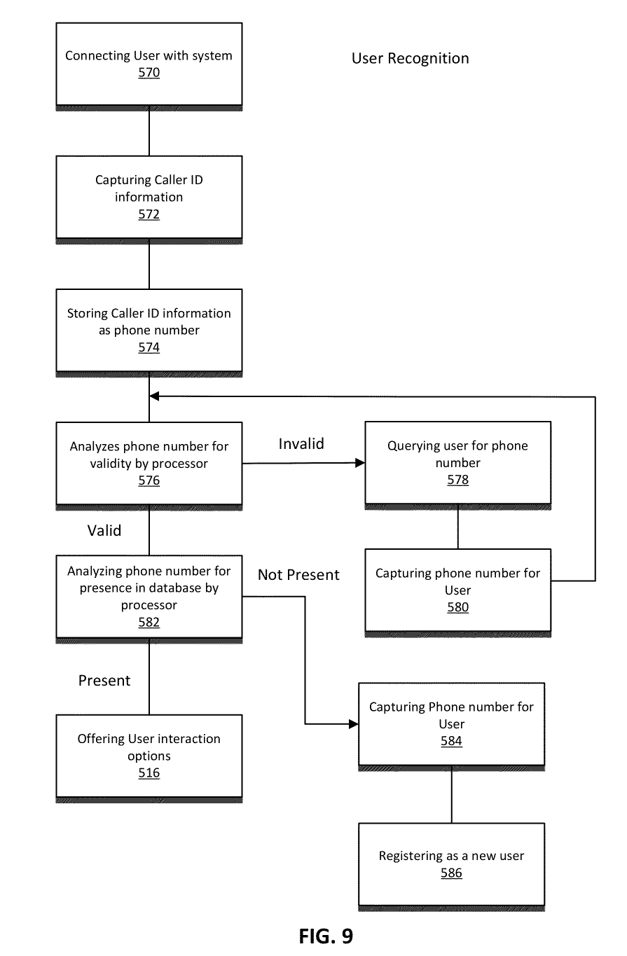

FIG. 9 illustrates one embodiment of the user recognition subsystem. Initially, a user 130 connects, at 570, with the system 100. The processor, 225, captures, at 572, the Caller ID information of the user 130. The processor 225 stores, at 574, the Caller ID information in the database 105. The processor 225 analyzes, at 576, the phone number for validity. If it is determined that the phone number is invalid, the processor 225 queries, at 578, the user 130 for another phone number. The processor 225 captures, at 580, the phone number provided by the user 130.

The processor 225 analyzes, at 582, the phone number for presence in the database 105. If the number is not in the system, the workplace information system 100 will capture, at 512, the phone number for the user 130. The processor 225 will register the caller as a new user 130. The processor 225, offers, at 584, the user 130 interaction options.

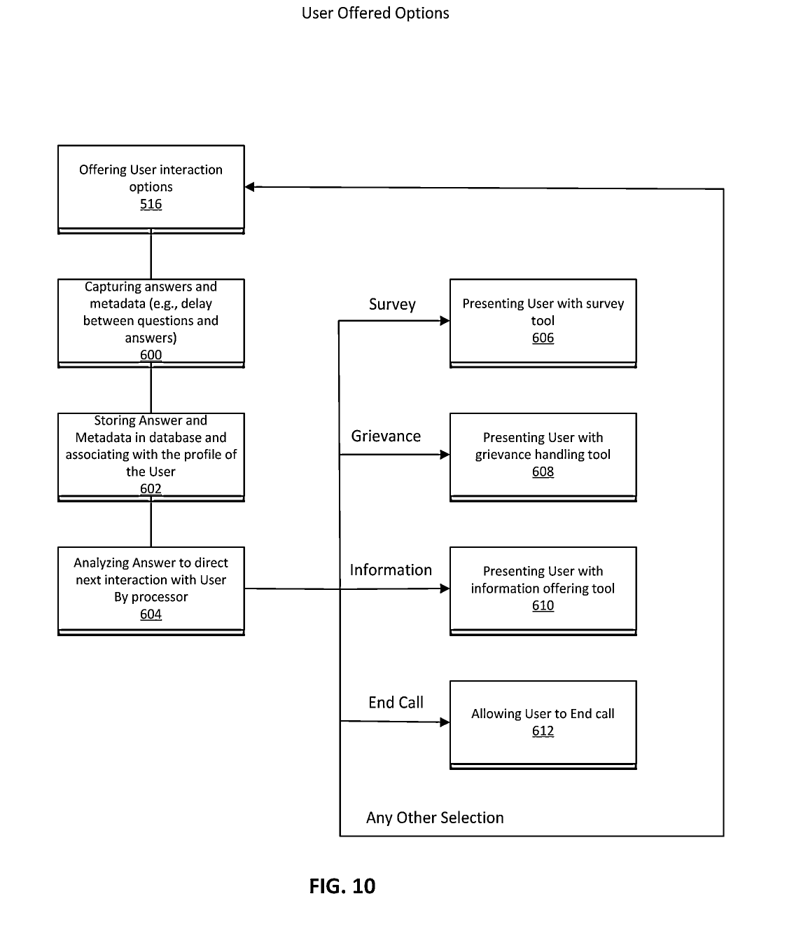

FIG. 10 illustrates one embodiment of the User Offered options. In the user offered options subsystem the processor 225 offers, at 516, the user 130 a list of user offered options. The processor 225 captures, at 600, the answers and metadata of the user 130. The metadata can include but is not limited to the delay between the questions and answers. The processor, at 225, can store, at 602, the answer and metadata in the database 105 and associate the information with the profile of the user 130. The processor 225 can analyze, at 604, the answers to direct the next interaction with the user 130. The user interaction options can include completing surveys, filing grievances, providing information, and ending call. Selecting the survey option, presents, at 606, the survey tool to the user 130. Selecting the grievance option, presents, at 608, the grievance handling tool to the user 130. Selecting the information option, presents, at 610, the information offering tool to the user 130. Selecting the end call option, terminates, at 612 the call with the user 130.

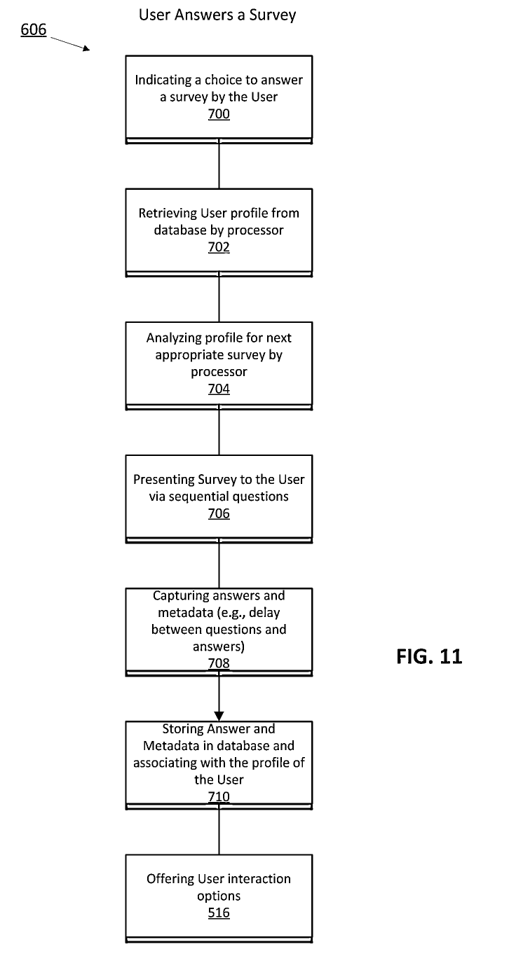

FIG. 11 illustrates one embodiment of the process of entering a survey. The user 130 initiates the survey tool by indicating, at 700, a choice to answer a survey. The processor 225 retrieves, at 702, the user profile from the database 105. The processor 225 analyzes, at 704, the profile of the user 130 to determine the appropriate survey. The processor 225 presents, at 706, to the user via sequential questions. The processor 225 captures, at 708, the answers and metadata (e.g., delay between the questions and answers). The processor 225 stores, at 710, the answers and metadata in the database 105 and associates the information with the profile of the user 130. Upon completion of the survey, the processor 225 offers, at 516, user interaction options.

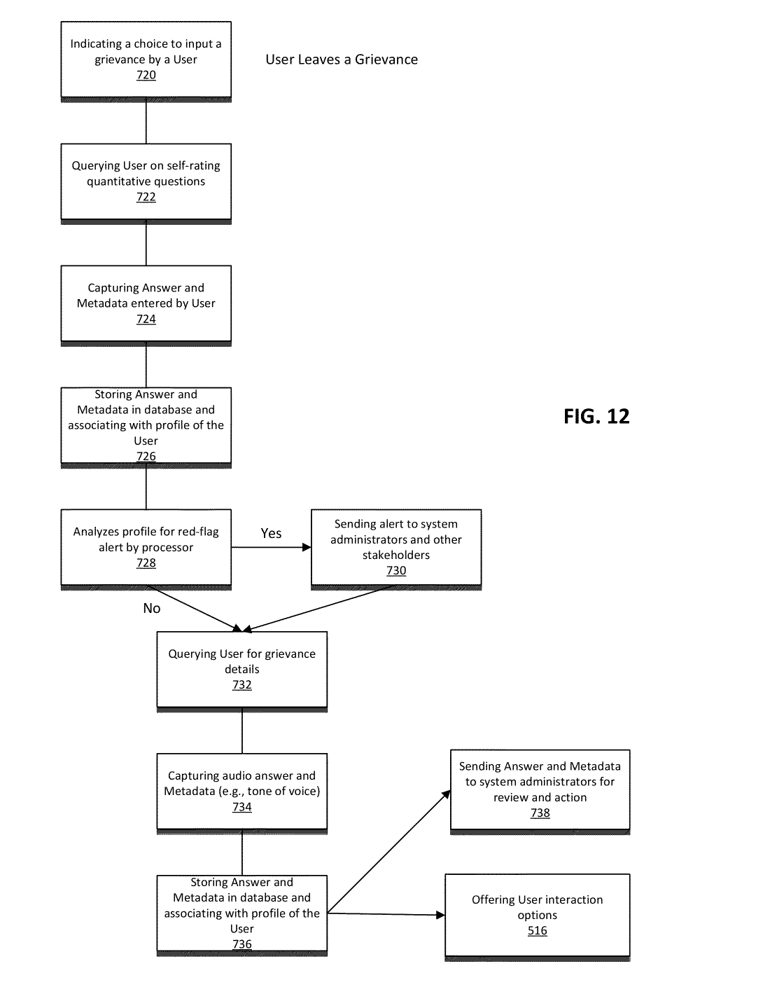

FIG. 12 illustrates one embodiment of the process of entering a grievance. The user 130 initiates the grievance process by indicating, at 720, a choice to input a grievance. The processor 225 queries, at 722, the user 130 using self-rating quantitative questions. The processor 225 captures, at 724, the answers and metadata entered by the User 130. The processor 225 stores, at 726, the answer and metadata and associates the profile with the user. The processor 225 analyzes, at 728, the profile and answers for any red-flag alerts. If the processor 225 detects any red-flag alerts, the processor 225 sends, at 730, an alert to system administrators and other stakeholders. The processor 225 queries, at 732, the user 130 for grievance details. The processor 225 captures, at 734, audio answers and metadata (e.g., tone of voice). The processor 225 stores, at 736, answers and metadata and associates with the profile of the user 130. The processor 225 can send, at 738, the answer and metadata to system administrators for review and action. Upon completion of entering the grievance, the system can offer, at 516, user interaction options.

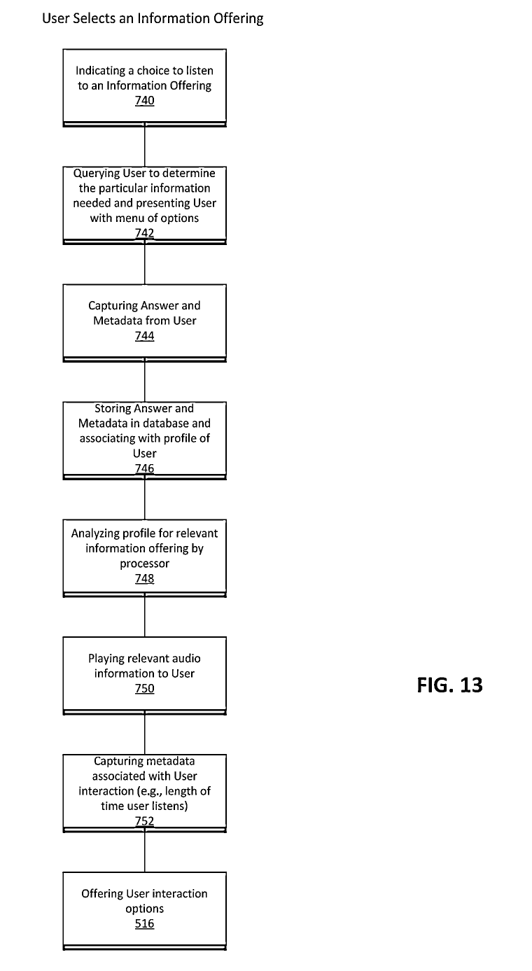

FIG. 13 illustrates one embodiment of the process of providing informational offerings. The user 130 initiates the information offering process by indicating, at 740, a choice to input a grievance. The processor 225 queries, at 742, the user 130 to determine the particular information needed and presents the user 130 with a menu of options. The processor 225 captures, at 744, the answer and metadata from the user 130. The processor 225 stores, at 746, the answer and metadata of a user 130. The processor 225 stores, at 746, the answers and metadata in the database 105 and associates the data with the profile of the user 105. The processor 225 analyzes, at 748, the profile of the user 130 for relevant informational offering. The processor 225 plays, at 750, relevant audio information to the user 105. The processor 225 captures, at 752, metadata associated with the user interaction (e.g., length of time user listens). Upon completion of the informational offering, the processor 225 offers, at 516, user interaction options.

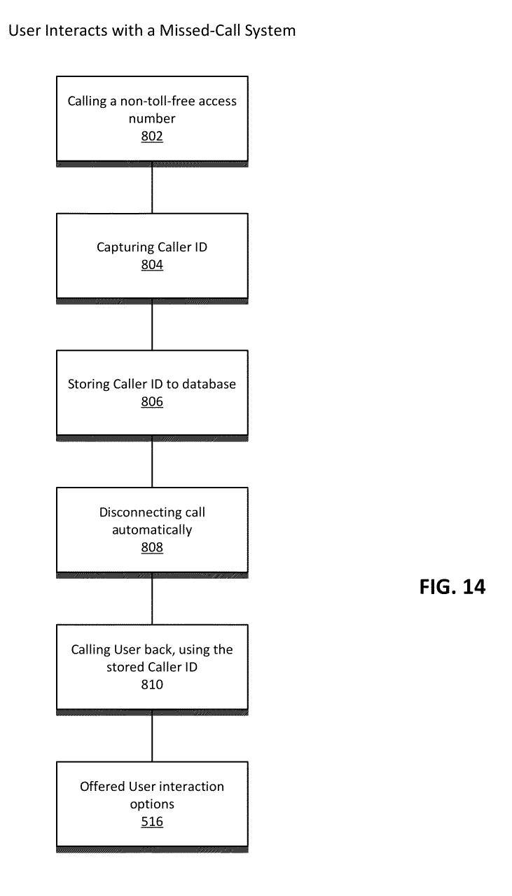

FIG. 14 illustrates one embodiment of interacting with the missed-call system. The user 130 can interact with the missed call system by calling, at 802, a non toll-free number. The processor 225 captures, at 804, the Caller ID information. The processor 225 can store, at 806, the Caller ID to the database 105. After capturing the Caller ID information, the processor 225 disconnects, at 808, the call automatically. The processor 225 calls, at 810, the user 130 back using the stored Caller ID information. After completion of the call, the processor 225 offers, at 516, the user interaction options.

In one embodiment a computer implemented method suitable for implementation on a processor 225 comprising: surveying an employee 130 of a certain workplace through use of a personal electronic device 235; identifying the employee 130 through a mobile phone number or a user identification code 205 associated with that employee 130; soliciting information regarding the workplace from the employee 130; recording the survey information 215 into a database 105; recording a plurality of metadata 220 information associated with said survey information 215 into the database 105; correlating the employee survey information 215 with the metadata 220; analyzing the survey information 215 to determine reliability based on correlation with the metadata 220; and assigning a weighting factor 310 to information based on reliability, wherein said surveying, identifying, soliciting, recording, correlating, analyzing, and assigning are performed by a processor 225.

In one embodiment of the computer implemented method, the analyzing of said information further comprises calculating an expectation value for the survey information, wherein said calculating is performed by the processor 225.

In one embodiment of the computer implemented method, the analyzing said information further comprises calculating a confidence value for the survey information, wherein said calculating is performed by the processor 225.

The disclosed embodiments are susceptible to various modifications and alternative forms, and specific examples thereof have been shown by way of example in the drawings and herein described in detail. It should be understood, however, that the disclosed embodiments are not meant to be limited to the particular forms or methods disclosed, but to the contrary, the disclosed embodiments are to cover all modifications, equivalents, and alternatives.

What is claimed is:

1. A method for providing workplace information for each of a predetermined number of workers, each of whom work for a common workplace, comprising:
associating a selected worker with a unique identifier and a trust factor value;
receiving information about the workplace from the selected worker via an associated electronic device;
comparing the information received with a plurality of reliable baseline information;
updating the trust factor value based on said comparing;
aggregating the information provided by each of said selected workers; and
generating an aggregate trust value from the updated trust value of each of the selected workers.

2. The method of claim 1, wherein said receiving information about the workplace comprises receiving quantified answers to a predetermined number of questions.

3. The method of claim 1, further comprising assigning priority to the information based on a customer selected criteria.

4. The method of claim 1, further comprising:
generating a report comprising of the aggregated information and the aggregated trust value; and
presenting the report upon customer request.

5. The method of claim 1, further comprising:
receiving a plurality of metadata associated with said selected worker; and
saving said metadata to a database.

6. The method of claim 5, further comprising:
comparing said metadata received with the reliable baseline information; and
updating the trust value based on said comparing.

7. The claim according to claim 5, further comprising identifying sections of workers based on the information received from the workers and the corresponding metadata.

8. The method of claim 7, further comprising electronically transmitting an informational offering to the selected worker or sections of workers based on the workplace information received and corresponding metadata.

9. The method of claim 1, wherein the trust value is provided a default value for said worker if said worker is new to the workplace information system.

10. The method of claim 1, wherein the electronic device comprises a cellular telephone.

11. The method of claim 1, further comprising calculating an expectation value based on information about the workplace received.

12. The method of claim 1, further comprising calculating a utility value for a survey completed by the selected worker.

13. The method of claim 1, further comprising providing the selected worker an option to review a workplace informational offering.

14. The method of claim 13, wherein said informational offering includes one of workplace pay information, workplace safety conditions, workplace hours, or worker rights.

15. The method of claim 1, further comprising calculating a confidence value for a survey completed by the selected worker.

16. A workplace information system, comprising:
an electronic device for entering a survey information regarding the workplace;
a network in communication with the electronic device;
a database server in communication with the network configured to record the survey information and a plurality of metadata associated with the electronic device; and
a processor in communication with said database configured to analyze the survey information and output a report.

17. The workplace information system of claim 16, further comprising an interactive voice message system for collecting workplace survey information.

18. A computer implemented method suitable for implementation on a processor comprising:
surveying an employee of a certain workplace through use of a personal electronic device;
identifying the employee through a mobile phone number or a user identification code associated with that employee;
soliciting information regarding the workplace from the employee;
recording the survey information into a database;
recording a plurality of metadata information associated with said survey information into the database;
correlating the employee survey information with the metadata;
analyzing the survey information to determine reliability based on correlation with the metadata; and
assigning a weighting factor to information based on reliability,
wherein said surveying, identifying, soliciting, recording, correlating, analyzing, and assigning are performed by a processor.

19. The computer implemented method of claim 18, wherein analyzing said information further comprises calculating an expectation value for the survey information, wherein said calculating is performed by the processor.

20. The computer implemented method of claim 18, wherein analyzing said information further comprises calculating a confidence value for the survey information, wherein said calculating is performed by the processor.
